(19) United States
(12) Patent Application Publication
(10) Pub. No.: US 2022/0367895 A1
(43) Pub. Date: Nov. 17, 2022

(54) MEMBRANE ELECTRODE ASSEMBLY AND METHOD FOR FABRICATING SAME

(71) Applicant: Giner, Inc., Newton, MA (US)

(72) Inventors: Derek J. Strasser, Marlborough, MA (US); Hui Xu, Acton, MA (US)

(21) Appl. No.: 17/743,303

(22) Filed: May 12, 2022

Related U.S. Application Data
(60) Provisional application No. 63/187,711, filed on May 12, 2021.

(51) Int. Cl. H01M 8/1004; H01M 8/1041

(52) U.S. Cl. CPC H01M 8/1004; H01M 8/1055; H01M 2008/1095

(57) ABSTRACT

Membrane electrode assembly and method for fabricating the same. In one embodiment, the method may involve providing an anion exchange membrane and then applying catalyst coatings to opposing surfaces of the anion exchange membrane, whereby a membrane electrode assembly may be formed. Next, the membrane electrode assembly may be subjected to a two-part treatment process. In a first part of the process, the membrane electrode assembly may be swelled, at room temperature, by exposure to an aqueous ethanol solution vapor while being retained under tension in a frame. The aqueous ethanol solution vapor may be, for example, 80:20 by volume ethanol and water. In a second part of the process, the swollen membrane electrode assembly may be removed from the frame and then pressed, at room temperature, between two plates. A layer of rubber and a layer polytetrafluoroethylene may be placed between each plate and the swollen membrane electrolyte assembly.

### CROSS-REFERENCE TO RELATED APPLICATIONS

The present application claims the benefit under 35 U.S.C. 119(e) of U.S. Provisional Patent Application No. 63/187,711, inventors Derek J. Strasser et al., filed May 12, 2021, the disclosure of which is incorporated herein by reference in its entirety.

### FEDERALLY SPONSORED RESEARCH OR DEVELOPMENT

This invention was made with government support under DE-EE0008438 awarded by the Department of Energy, Energy Efficiency and Renewable Energy (DOE EERE). The government has certain rights in the invention.

### BACKGROUND OF THE INVENTION

The present invention relates generally to electrochemical devices of the type that comprise a solid polymer electrolyte membrane and relates more particularly to membrane electrode assemblies comprising solid polymer electrolyte membranes and to methods of fabricating the same.

Electrochemical devices of the type that include a solid polymer electrolyte membrane are well-known, examples of such devices including fuel cells, electrolyzers, and the like. One well-known type of solid polymer electrolyte membrane is commonly referred to in the art as a proton exchange membrane. Proton exchange membranes typically consist of a homogeneous perfluorosulfonic acid (PFSA) polymer, which may be formed by the copolymerization of tetrafluoroethylene and perfluorovinylether sulfonic acid. Proton exchange membranes are designed to conduct protons but are poor conductors of electrons and have low permeability to gases like hydrogen and oxygen.

Another well-known type of solid polymer electrolyte membrane is commonly referred to in the art as an anion exchange membrane (AEM). AEMs may be made by appropriately functionalizing materials like polyethylene, polypropylene, polystyrene, polyarylene, poly(phenylene oxide), polybutadiene, polynorbornene, poly(aryl piperidinium) and similar materials. Like proton exchange membranes, AEMs are poor conductors of electrons and have low permeability to gases like hydrogen and oxygen. On the other hand, whereas proton exchange membranes are designed to conduct protons, AEMs are designed to conduct anions, such as hydroxide ions.

Typically, in an electrochemical device of the type that comprises a solid polymer electrolyte membrane, a suitable catalyst coating is positioned against each of the opposing surfaces of the solid polymer electrolyte membrane, the catalyst coatings serving as the anode and the cathode of the electrochemical device. In some cases, this is accomplished by applying the catalyst coatings directly onto the opposing surfaces of the solid polymer electrolyte membrane. Alternatively, in some cases, this is accomplished by applying the catalyst coatings onto suitable substrates like gas diffusion media (e.g., carbon paper) and then positioning the coated substrates so that the catalyst coatings are disposed against the opposing surfaces of the solid polymer electrolyte membrane. In either case, whether the catalyst coatings are applied directly onto the solid polymer electrolyte membrane or whether the catalyst coatings are applied to a substrate, which is then positioned against the solid polymer electrolyte membrane, the resulting multi-layered structure is commonly referred to as a membrane electrode assembly (MEA). An electrochemical device may have a single such membrane electrode assembly or may include a plurality of membrane electrode assemblies, which may be arranged in series.

Where, for example, the solid polymer electrolyte membrane is to be used in a fuel cell, the catalyst coating on one surface of the solid polymer electrolyte membrane may be an oxygen reduction reaction (ORR) catalyst, and the catalyst coating on the opposing surface of the solid polymer electrolyte membrane may be a hydrogen oxidation reaction (HOR) catalyst. By contrast, where the solid polymer electrolyte membrane is to be used in an electrolyzer, the catalyst coating on one surface of the solid polymer electrolyte membrane may be an oxygen evolution reaction (OER) catalyst, and the catalyst coating on the opposing surface of the solid polymer electrolyte membrane may be a hydrogen evolution reaction (HER) catalyst.

As can readily be appreciated, the manner in which a membrane electrode assembly is fabricated may have a significant impact on its performance and durability and, correspondingly, may affect the performance and durability of an electrochemical device that includes such a membrane electrode assembly. For example, high-performance membrane electrode assemblies typically exhibit excellent contact between the membrane and the catalyst coatings, resulting in high ionic conductivity and decreased interfacial resistance. Therefore, fabrication techniques that result in good contact between the membrane and the catalyst coatings are highly coveted.

Where the solid polymer electrolyte membrane is a proton exchange membrane, such contact between the membrane and the catalyst coatings is typically achieved, after the catalyst coatings have been directly applied to the membrane or after the catalyst coatings have been directly applied to a substrate that is then positioned against the membrane, by a post-treatment step that involves hot-pressing the catalyst coatings against the membrane at an elevated temperature (e.g., 300° F.-360° F.) that is above the glass transition temperature (T_{g}) of the membrane, causing the catalyst coatings to fuse to and/or to become partially embedded in the membrane. Such processing is made possible by the fact that proton exchange membranes typically exhibit thermal transitions at temperatures that are significantly lower than their thermal degradation reaction temperatures. Consequently, the aforementioned hot-pressing technique can be used to slightly soften the membrane, thereby causing the catalyst layers to bond to the softened membrane, without causing degradation of the membrane.

By contrast, the thermal characteristics of many anion exchange membranes are such that an onset of thermal degradation is often exhibited at a temperature that is lower than the glass transition temperature (T_{g}) of the membrane. As a result, the same type of hot-pressing post-treatment technique that is used to obtain good contact between a proton exchange membrane and its catalyst coatings cannot typically be used to obtain good contact between an anion exchange membrane and its catalyst coatings since the anion exchange membrane will start to degrade before it softens sufficiently for the catalyst coatings to fuse thereto.

### SUMMARY OF THE INVENTION

It is an object of the present invention to provide a novel method for fabricating a membrane electrode assembly.

It is another object to provide a method as described above that it is particularly well-suited for fabricating a membrane electrode assembly of the type that comprises an anion exchange membrane.

It is yet another object of the present invention to provide a method as described above that overcomes at least some of the shortcomings associated with existing methods for fabricating membrane electrode assemblies, particularly those of the type comprising an anion exchange membrane.

Therefore, according to one aspect of the invention, there is provided a method for fabricating a membrane electrode assembly, the method comprising the following steps: (a) providing a solid polymer electrolyte membrane; (b) positioning catalyst coatings against opposing surfaces of the solid polymer electrolyte membrane; (c) then, swelling/plasticizing the solid polymer electrolyte membrane with a vapor of an aqueous ethanol solution; and (d) then, pressing the catalyst coatings against the solid polymer electrolyte membrane to fuse and/or to partially embed the catalyst coatings into the solid polymer electrolyte membrane.

In a more detailed feature of the invention, the pressing step may be performed at a temperature less than 100° C.

In a more detailed feature of the invention, each of the swelling/plasticizing step and the pressing step may be performed at room temperature.

In a more detailed feature of the invention, the solid polymer electrolyte membrane may comprise an anion exchange membrane.

In a more detailed feature of the invention, the anion exchange membrane may be a hydroxide exchange membrane.

In a more detailed feature of the invention, the hydroxide exchange membrane may be formed by functionalizing a material selected from the group consisting of polyethylene, polypropylene, polystyrene, polyarylene, poly(phenylene oxide), polybutadiene, polynorbornene, and poly(aryl piperidinium).

In a more detailed feature of the invention, the anion exchange membrane may have a thickness of about 20-180 microns.

In a more detailed feature of the invention, the anion exchange membrane may have a thickness of about 80 microns.

In a more detailed feature of the invention, the catalyst coatings positioning step may comprise depositing an ionomer/catalyst ink on the solid polymer electrolyte membrane.

In a more detailed feature of the invention, the catalyst coatings positioning step may comprise positioning at least one catalyst-coated substrate against the solid polymer electrolyte membrane.

In a more detailed feature of the invention, one of the catalyst coatings may comprise a first catalyst, the first catalyst may be suitable for at least one of a hydrogen evolution reaction or a hydrogen oxidation reaction, another one of the catalyst coatings may comprise a second catalyst, and the second catalyst may be suitable for at least one of an oxygen evolution reaction or an oxygen reduction reaction.

In a more detailed feature of the invention, the aqueous ethanol solution may comprise ethanol and water in relative amounts that range from 1:10 to 4:1, by volume, respectively.

In a more detailed feature of the invention, the aqueous ethanol solution may comprise ethanol and water in a 4:1 ratio, by volume, respectively.

In a more detailed feature of the invention, the swelling/plasticizing step may be performed in a sealed container for a duration of about 10-100 minutes.

In a more detailed feature of the invention, during the swelling/plasticizing step, the solid polymer electrolyte membrane may be retained under tension in a frame.

In a more detailed feature of the invention, the pressing step may comprise applying a force of about 1000-10,000 lbs. for about 2-30 minutes.

In a more detailed feature of the invention, the pressing step may comprise pressing the catalyst coatings against the solid polymer electrolyte membrane using a pair of mold plates.

In a more detailed feature of the invention, the pressing step may comprise pressing the catalyst coatings against the solid polymer electrolyte membrane using a pair of mold plates that may be separated by a pair of rubber layers that, in turn, may be separated by a pair of polytetrafluoroethylene layers.

The present invention is also directed at a membrane electrode assembly made by the method described above.

The present invention is also directed at an electrochemical device that comprises the membrane electrode assembly described above.

According to another aspect of the invention, there is provided a method for applying a catalyst coating to a solid polymer electrolyte membrane, the method comprising the following steps: (a) providing a solid polymer electrolyte membrane; (b) positioning a catalyst coating against a surface of the solid polymer electrolyte membrane; (c) then, swelling or plasticizing the solid polymer electrolyte membrane with a vapor of an aqueous ethanol solution; and (d) then, pressing the catalyst coating against the solid polymer electrolyte membrane to fuse and/or to partially embed the catalyst coating into the solid polymer electrolyte membrane.

In a more detailed feature of the invention, the pressing step may be performed at a temperature less than 100° C.

In a more detailed feature of the invention, each of the swelling/plasticizing step and the pressing step may be performed at room temperature.

In a more detailed feature of the invention, the solid polymer electrolyte membrane may be an anion exchange membrane.

In a more detailed feature of the invention, the aqueous ethanol solution may comprise ethanol and water in relative amounts that range from 1:10 to 4:1, by volume, respectively.

In a more detailed feature of the invention, the swelling/plasticizing step may be performed in a sealed container for a duration of about 10-100 minutes.

In a more detailed feature of the invention, during the swelling/plasticizing step, the solid polymer electrolyte membrane may be retained under tension in a frame.

In a more detailed feature of the invention, the pressing step may comprise applying a force of about 1000-10,000 lbs. for about 2-30 minutes.

In a more detailed feature of the invention, the pressing step may comprise pressing the catalyst coatings against the solid polymer electrolyte membrane using a pair of mold plates.

In a more detailed feature of the invention, the catalyst coating positioning step may comprise depositing an ionomer/catalyst ink on the solid polymer electrolyte membrane.

In a more detailed feature of the invention, the catalyst coating positioning step may comprise positioning a catalyst-coated substrate against the solid polymer electrolyte membrane.

The present invention is also directed at a coated solid polymer electrolyte membrane made by the method described above.

The present invention is also directed at an electrochemical device that comprises the coated solid polymer electrolyte membrane described above.

For purposes of the present specification and claims, various relational terms like “top,” “bottom,” “proximal,” “distal,” “upper,” “lower,” “front,” and “rear” may be used to describe the present invention when said invention is positioned in or viewed from a given orientation. It is to be understood that, by altering the orientation of the invention, certain relational terms may need to be adjusted accordingly.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. These drawings are not necessarily drawn to scale, and certain components may have undersized and/or oversized dimensions for purposes of explication or may omit certain features for purposes of clarity. In the drawings wherein like reference numeral represent like parts:

FIG. 1 is a flowchart showing one embodiment of a method for fabricating a membrane electrode assembly according to the present invention;

FIG. 2 is an exploded perspective view of one embodiment of a frame assembly that may be used to apply a catalyst coating to a solid polymer electrolyte membrane in accordance with the method of FIG. 1, the frame assembly being shown with a solid polymer electrolyte membrane;

FIGS. 3A and 3B are top and bottom views, respectively, of one embodiment of a membrane electrode assembly that may be made using the frame assembly of FIG. 2;

FIG. 4 is a section view of the membrane electrode assembly of FIG. 3A taken along line 4-4;

FIG. 5 is a simplified schematic view of one embodiment of a setup that may be used to perform the first part of the two-part post-treatment process of the present invention;

FIG. 6 is a simplified exploded side view of one embodiment of a setup that may be used to perform the second part of the two-part post-treatment process of the present invention;

FIGS. 7A and 7B are top and bottom views, respectively, of one embodiment of a membrane electrode assembly fabricated using the method of FIG. 1;

FIG. 8 is a section view of the membrane electrode assembly taken along line 8-8 in FIG. 7A;

FIG. 9 is a schematic representation of an electrochemical device comprising the membrane electrode assembly of FIG. 7A;

FIG. 10 is a graph depicting the performance of the membrane of Example 1 when operated at 500 mA/cm² for 500 hours; and

FIG. 11 is a graph depicting the performance of the membrane of Example 2 when operated at 1000 mA/cm2 for over 300 hours.

### DETAILED DESCRIPTION OF THE INVENTION

As noted above, one common difficulty in fabricating a membrane electrode assembly that comprises an anion exchange membrane is that, for many such anion exchange membranes, the anion exchange membrane begins to experience thermal degradation at a temperature that is lower than the glass transition temperature (T_{g}) of the membrane. Consequently, such anion exchange membranes are typically not amenable to having catalyst coatings hot-pressed thereonto. As a result, in many cases, membrane electrode assemblies that comprise anion exchange membranes do not exhibit the same type of close contact between the membrane and the catalyst coatings that is typically exhibited by membrane electrode assemblies that are made by a process that includes such hot-pressing.

Against this backdrop, an objective of the present invention is to provide a technique that presents the benefits of hot-pressing catalyst coatings onto a membrane without actually requiring the types of temperatures typically involved in hot-pressing. In this manner, one may avoid having the membrane undergo the type of thermal degradation that is typically experienced with hot-pressing.

According to one aspect of the invention, the foregoing objective may be achieved by employing a technique that, amongst other things, effectively reduces the glass transition temperature of the membrane to a temperature that is below its thermal degradation temperature. In fact, in at least some cases, the glass transition temperature of the membrane may be lowered to an extent that enables catalyst coatings to fuse to and/or to be pressed into the membrane at a temperature less than 100° C., preferably at room temperature.

More specifically, according to one embodiment of the invention, a method for fabricating a membrane electrode assembly may comprise the following steps: (a) providing a solid polymer electrolyte membrane; (b) positioning catalyst coatings against opposing surfaces of the solid polymer electrolyte membrane—either by depositing the catalyst coatings directly on the solid polymer electrolyte membrane or by depositing the catalyst coatings on suitable substrates (e.g., gas diffusion media like carbon paper or the like) and positioning the coated substrates so that the catalyst coatings are disposed against the solid polymer electrolyte membrane; (c) then, swelling or plasticizing the solid polymer electrolyte membrane, preferably at room temperature, with an aqueous ethanol solution vapor; and (d) then, pressing, preferably at room temperature, the catalyst coatings against the solid polymer electrolyte membrane to fuse and/or to partially embed the catalyst coatings into the solid polymer electrolyte membrane.

The solid polymer electrolyte membrane of the present invention may be, but is not limited to, a conventional solid polymer electrolyte membrane and preferably is, but is not limited to, an anion exchange membrane, particularly an anion exchange membrane that is capable of conducting hydroxide ions. Examples of suitable anion exchange membranes may include, but are not limited to, conventional anion exchange membranes, such as those made by appropriately functionalizing materials like polyethylene, polypropylene, polystyrene, polyarylene, poly(phenylene oxide), polybutadiene, polynorbornene, poly(aryl piperidinium) and similar materials. In at least some cases, the foregoing anion exchange membrane may have a thickness of approximately 20-180 microns.

The catalyst coatings of the present invention may be, but are not limited to, conventional catalyst coatings of the type that are commonly applied, either directly or indirectly, to solid polymer electrolyte membranes, particularly anion exchange membranes. For example, and without limitation, a first catalyst coating may be formed by depositing directly onto the membrane, or onto a substrate that, in turn, is positioned against the membrane, an ionomer ink containing a catalyst material suitable for the hydrogen evolution reaction (HER) or the hydrogen oxidation reaction (HOR). More specifically, said catalyst may consist of or comprise one or more platinum group metal (PGM) HER/HOR catalysts (e.g., platinum, palladium, ruthenium, etc.) or may consist of or comprise one or more PGM-free HER/HOR catalysts (e.g., iron, nickel, cobalt, manganese, copper, etc.). The second catalyst coating may be formed by depositing onto the membrane, or onto a substrate that, in turn, is positioned against the membrane, an ionomer ink containing a catalyst material suitable for the oxygen evolution reaction (OER) or the oxygen reduction reaction (ORR). More specifically, said catalyst may consist of or comprise one or more PGM OER/ORR catalysts (e.g., platinum, iridium, ruthenium, or their alloys like PtCo, PtNi, PtFe, PtIr, IrRu, etc.) or may consist of or comprise one or more PGM-free OER/ORR catalysts (e.g., iron, nickel, cobalt, manganese, copper, or one or more oxides of the foregoing metals). For example, where the solid polymer electrolyte membrane is an anion exchange membrane and where the membrane electrode assembly is to be used in a water electrolyzer with pure water as the feed, the cathode catalyst coating may comprise PtRu/C and/or a PGM-free catalyst, and the anode catalyst coating may comprise iridium oxide and/or a PGM-free catalyst.

The catalyst coatings of the present invention may be formed by conventional techniques. For example, and without limitation, a suitable catalyst may be incorporated into an ionomer ink, and then the catalyst/ionomer ink may be deposited onto an area of the solid polymer electrolyte membrane by spray-coating, painting, or any other suitable deposition technique. During said deposition technique, the solid polymer electrolyte membrane may be held in a frame (which may be made of metal or another suitable material) such that a peripheral portion of the membrane is covered by the frame, with a central (i.e., active) portion of the membrane being exposed for deposition of the catalyst/ionomer inks thereon. Alternatively, the catalyst/ionomer ink may be deposited onto an area of a suitable substrate, such as a gas diffusion medium (e.g., carbon paper), by spray-coating, painting, or any other suitable deposition technique, and the coated substrate may then be positioned against the solid polymer electrolyte membrane.

Once the catalyst coatings are positioned against the opposing surfaces of the solid polymer electrolyte membrane in the manner described above (whereby a membrane electrode assembly is formed), the membrane electrode assembly may be subjected to a two-part post-treatment process. In a first part of the two-part treatment process, the membrane electrode assembly may be swollen with fluid or plasticized in order to lower its glass transition temperature. Such swelling or plasticizing may be conducted at room temperature and may be effected by positioning the membrane, retained under tension by the above-discussed peripheral frame, in a sealed chamber and exposing the tensioned membrane to a vapor of an aqueous ethanol solution. Said aqueous ethanol solution may consist of or comprise ethanol and water in relative amounts that range from 1:10 to 4:1, by volume, respectively. The relative amounts of ethanol and water in the aqueous ethanol solution may vary, depending, for example, on the composition of the membrane. The foregoing swelling or plasticizing step may be complete when the membrane has visibly swollen or become wrinkled, albeit not to the point of tearing. The swelling or plasticizing step may take approximately 10-100 minutes and typically takes at least 30 minutes.

The second part of the two-part post-treatment process may comprise removing the membrane electrode assembly from the above-described peripheral frame and pressing the membrane electrode assembly, preferably at a temperature less than 100° C., more preferably at room temperature, between a pair of rigid plates for an extended period of time to fuse and/or to partially embed the catalyst coatings into the membrane. In a preferred embodiment, the applied pressing force may be approximately 1000-10,000 lbs., and the duration of pressing may be approximately 2-30 minutes, preferably 5-20 minutes. In addition, interposed between the membrane electrode assembly and each of the rigid plates, there may be a layer of hard rubber and a layer of TEFLON™ polytetrafluoroethylene, with the former proximate to the rigid plate and the latter proximate to the membrane electrode assembly. The foregoing combination of TEFLON™ polytetrafluoroethylene and rubber layers may be used to ensure (i) that uniform force is being applied to the membrane electrode assembly and (ii) that the catalyst coatings of the membrane electrode assembly do not stick to the press or become damaged during pressing.

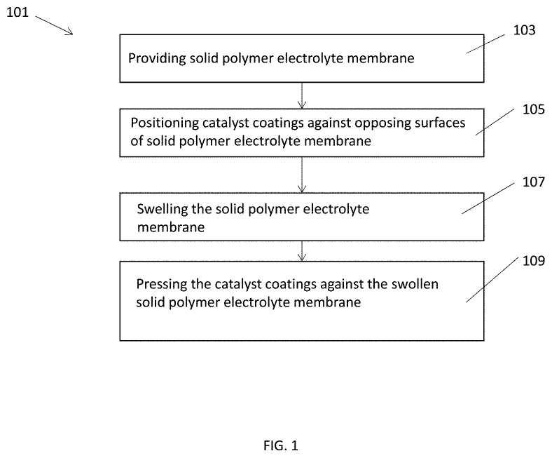

Referring now to FIG. 1, there is shown a flowchart depicting one embodiment of a method for fabricating a membrane electrode assembly according to the present invention, the method being represented generally by reference numeral 101. Details of method 101 that are discussed elsewhere in this application or that are not critical to an understanding of the invention may be omitted from FIG. 1 and/or from the accompanying description herein or may be shown in FIG. 1 and/or described herein in a simplified manner.

Method 101 may begin with a step 103 of providing a solid polymer electrolyte membrane. The solid polymer electrolyte membrane may be a solid polymer electrolyte membrane of the type described above and, for example, may be an anion electrode membrane of the type capable of conducting hydroxide ions. Examples of such anion electrode membranes may include appropriately functionalized membranes made of polyethylene, polypropylene, polystyrene, polyarylene, poly(phenylene oxide), polybutadiene, polynorbornene, poly(aryl piperidinium) or similar materials. Optionally, step 103 may include a pre-treatment step of hydrating the solid polymer electrolyte membrane, preferably in room temperature water, while being retained in a metal frame under tension, exposing only the future active area, and then dried.

Method 101 may then continue with a step 105 of positioning catalyst coatings against opposing surfaces of the solid polymer electrolyte membrane. This may be accomplished in a variety of ways. For example, according to one technique, the solid polymer electrolyte membrane may be mounted in a peripheral frame, and then catalyst coatings may be applied to the exposed opposed central portions of the solid polymer electrolyte membrane. Alternatively, according to another technique, catalyst coatings may be applied to suitable substrates, such as gas diffusion media (e.g., carbon paper), and two such coated substrates may be positioned relative to the solid polymer electrolyte membrane so that their catalyst coatings directly contact opposing surfaces of the solid polymer electrolyte membrane. In either case, the production of the catalyst coatings may be achieved by formulating an ink that comprises one or more suitable ionomers and one or more suitable catalysts and then spray-coating, painting or otherwise appropriately applying the ink to the appropriate object.

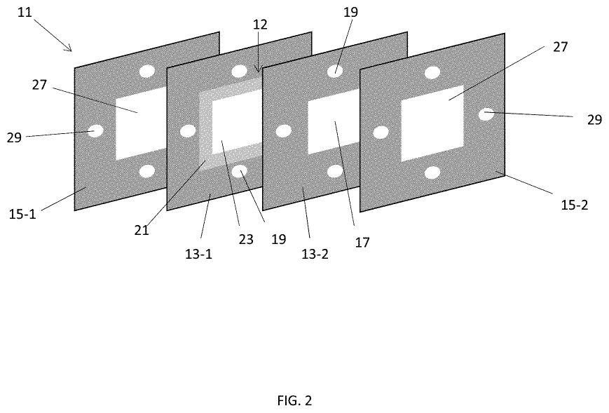

Referring now to FIG. 2, there is shown an exploded perspective view of a frame assembly that may be used in performance of at least one of the embodiments of step 105, the frame assembly being represented generally by reference numeral 11. Details of frame assembly 11 that are discussed elsewhere in this application or that are not critical to an understanding of the invention may be omitted from FIG. 2 and/or from the accompanying description herein or may be shown in FIG. 2 and/or described herein in a simplified manner.

Frame assembly 11, which is shown together with a solid polymer electrolyte membrane 12, may comprise a pair of inner frame members 13-1 and 13-2 and a pair of outer frame members 15-1 and 15-2. Inner frame members 13-1 and 13-2 may be identical to one another in size, shape, and composition, and each may comprise a metal member of generally rectangular shape having a central opening 17 and a plurality of peripheral openings 19. Central openings 17 of inner frame members 13-1 and 13-2 may be generally rectangular in shape and may be dimensioned and positioned relative to solid polymer electrolyte membrane 12 to define a peripheral inactive area 21 and a central active area 23. Outer frame members 15-1 and 15-2 may be identical to one another in size, shape, and composition, and each may comprise a metal member of generally rectangular shape having a central opening 27 and a plurality of peripheral openings 29. Outer frame members 15-1 and 15-2 may have outer dimensions that are similar or identical to those of inner frame members 13-1 and 13-2, and peripheral openings 29 of outer frame members 15-1 and 15-2 may be alignable with peripheral openings 19 of inner frame members 13-1 and 13-2. In this manner, inner frame members 13-1 and 13-2 and outer frame members 15-1 and 15-2 may be removably secured to one another with bolts or other suitable fasteners inserted through peripheral openings 19 and 29. In addition, central openings 27 of outer frame members 15-1 and 15-2 may be alignable with central openings 17 of inner frame members 13-1 and 13-2 to provide access to central active area 23 of solid polymer electrolyte membrane 12. In the present embodiment, central openings 27 of outer frame members 15-1 and 15-2 are slightly larger than central openings 17 of inner frame members 13-1 and 13-2, but this need not necessarily be the case.

In use, a solid polymer electrolyte membrane 12 may be secured, for example, via tape to an inner facing surface of one of inner frame members 13-1 and 13-2, with solid polymer electrolyte membrane 12 being centered over central opening 17. Inner frame members 13-1 and 13-2 and outer frame members 15-1 and 15-2 may then be secured to one another with suitable fasteners inserted through peripheral openings 19 and 29. Catalyst coatings may then be deposited on the opposing surfaces of central active area 23 of solid polymer electrolyte member 12.

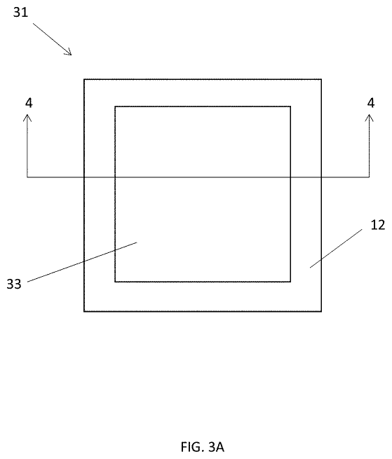

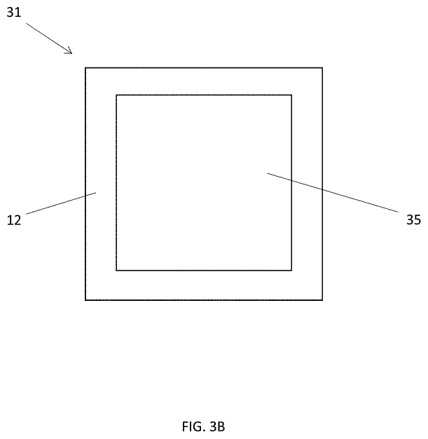

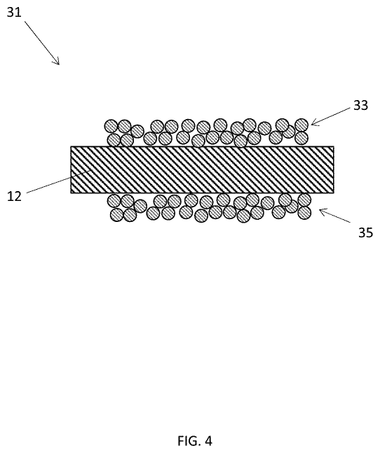

Referring now to FIGS. 3A, 3B, and 4, there are shown various views of a membrane electrode assembly 31 that may be formed in the foregoing manner. As can be seen, membrane electrode assembly 31 comprises solid polymer electrolyte membrane 12, a first catalyst coating 33 applied to one of the major opposing surfaces of solid polymer electrolyte membrane 12, and a second catalyst coating 35 applied to the other of the major opposing surfaces of solid polymer electrolyte membrane 12. (For simplicity and clarity, only the catalyst component of catalyst coatings 33 and 35 is schematically shown in FIG. 4.)

Referring back now to FIG. 1, method 101 may then continue with a step 107 of swelling or plasticizing the solid polymer electrolyte membrane, preferably at room temperature, with the vapor of an aqueous ethanol solution. Said aqueous ethanol solution may consist of or comprise ethanol and water in relative amounts that range from 1:10 to 4:1, by volume, respectively. The relative amounts of ethanol and water in the aqueous ethanol solution may vary, depending, for example, on the composition of the solid polymer electrolyte membrane. The foregoing swelling or plasticizing step may be complete when the solid polymer electrolyte membrane has visibly swollen or become wrinkled, albeit not to the point of tearing. The swelling or plasticizing step may take approximately 10-100 minutes and typically takes at least 30 minutes.

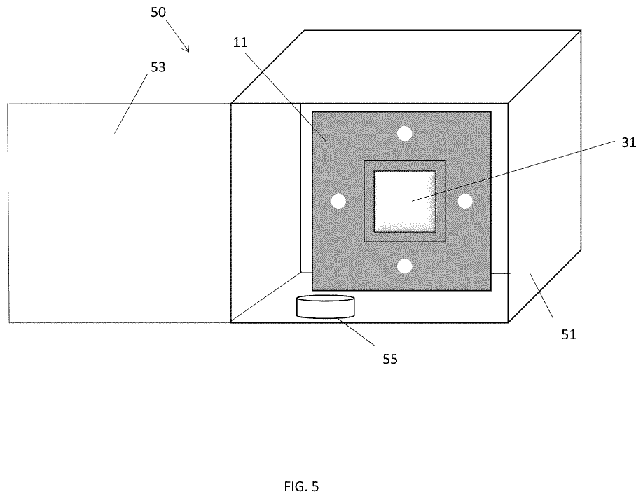

An example of a setup that may be used to perform step 107 is schematically shown in FIG. 5 and is represented generally by reference numeral 50. (Certain details of setup 50 that are discussed elsewhere in this application or that are not critical to an understanding of the invention may be omitted from FIG. 5 and/or from the accompanying description herein or may be shown in FIG. 5 and/or described herein in a simplified manner.) Setup 50 may comprise a sealable chamber 51 into which the combination of membrane electrode assembly 31 and frame assembly 11 may be removably positioned. (The combination of membrane electrode assembly 31 and frame assembly 11 may be transferred “as is” following step 105 and positioned within sealable chamber 51, and sealable chamber 51 may contain air at about 1 atm.) Although sealable chamber 51 is shown in FIG. 5 as a box having a closable door 53, it is to be understood that sealable chamber 51 need not take the form shown and could be, for example, a re-sealable plastic bag. Setup 50 may further comprise a vial 55 disposed within sealable chamber 51, vial 55 containing a quantity of an aqueous ethanol solution. Vial 55, which may be, for example, a 10 ml vial containing 7-8 ml of the aqueous ethanol solution, may be uncovered or may include one or more openings to permit the aqueous ethanol solution in vapor form to escape into sealable chamber 51, whereupon it may swell membrane electrode assembly 31.

Although step 107 is described above as having the catalyst coatings applied directly to the solid polymer electrolyte membrane, it is to be understood that such catalyst coatings could instead by applied to a suitable substrate, such as a gas diffusion medium (e.g., carbon paper), and the coated substrates could then be positioned against the solid polymer electrolyte membrane. In such a case, the combination of the solid polymer electrolyte membrane and the catalyst-coated substrates would be mounted within frame assembly 11 and positioned within sealable chamber 51.

Referring back now to FIG. 1, method 101 may then continue with a step 109 of pressing, preferably at a temperature less than 100° C., more preferably at room temperature, the catalyst coatings against the solid polymer electrolyte membrane to fuse and/or to partially embed the catalyst coatings into the solid polymer electrolyte membrane. In a preferred embodiment, the applied pressing force may be approximately 1000-10,000 lbs., and the duration of pressing may be approximately 2-30 minutes, preferably 5-20 minutes.

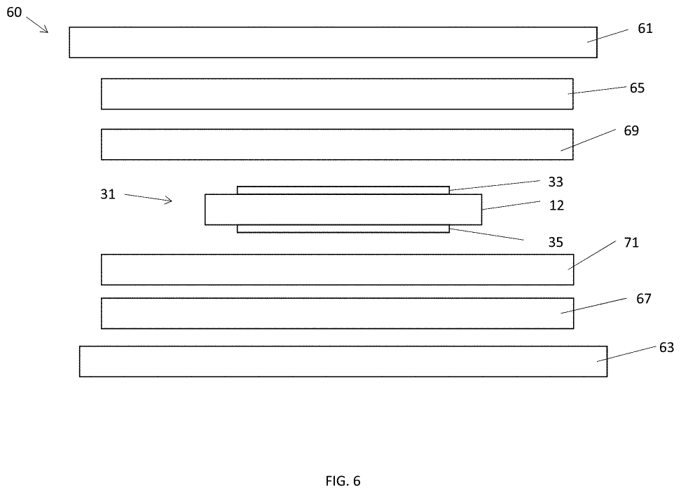

An example of a setup that may be used to perform step 109 is schematically shown in FIG. 6 and is represented generally by reference numeral 60. (Certain details of setup 60 that are discussed elsewhere in this application or that are not critical to an understanding of the invention may be omitted from FIG. 6 and/or from the accompanying description herein or may be shown in FIG. 6 and/or described herein in a simplified manner.)

Setup 60 is shown together with membrane electrode assembly 31, which is removed from frame assembly 11 following the conclusion of step 107. Setup 60 may comprise a press. More specifically, setup 60 may comprise a top pressing mold plate 61 and a bottom pressing mold plate 63, both of which may be made of a rigid material, such as steel. A mechanism (not shown) may be used to selectively move one or both of top pressing mold plate 61 and bottom pressing mold plate 63 relative to one another to provide a compressive force to membrane electrode assembly 31 such that catalyst coatings 33 and 35 are pressed inwardly towards solid polymer electrolyte membrane 12.

Setup 60 may further comprise a top hard rubber layer 65 disposed along the bottom surface of top pressing mold plate 61, a bottom hard rubber layer 67 disposed along the top surface of bottom pressing mold plate 63, a top TEFLON™ polytetrafluoroethylene layer 69 disposed along the bottom surface of top hard rubber layer 65, and a TEFLON™ polytetrafluoroethylene layer 71 disposed along the top surface of bottom hard rubber layer 67. The combination of top hard rubber layer 65, bottom hard rubber layer 67, top TEFLON™ polytetrafluoroethylene layer 69, and bottom TEFLON™ polytetrafluoroethylene layer 71 may help to ensure (i) that uniform force is being applied to membrane electrode assembly 31 and (ii) that catalyst coatings 33 and 35 of membrane electrode assembly 31 do not stick to the press or become damaged during pressing. Setup 60 is preferably used to apply sufficient force to cause catalyst coatings 33 and 35 to fuse to and/or to become at least partially embedded within solid polymer electrolyte membrane 12. Once step 109 is complete, the pressed membrane electrode assembly may be removed from setup 60.

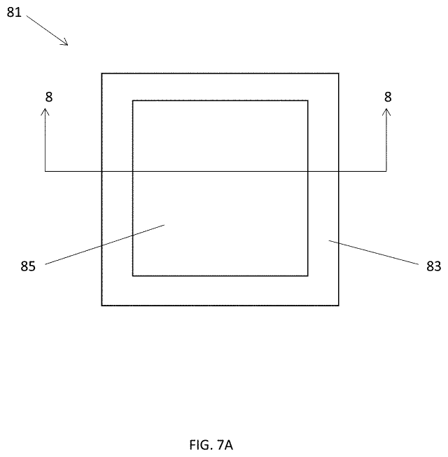

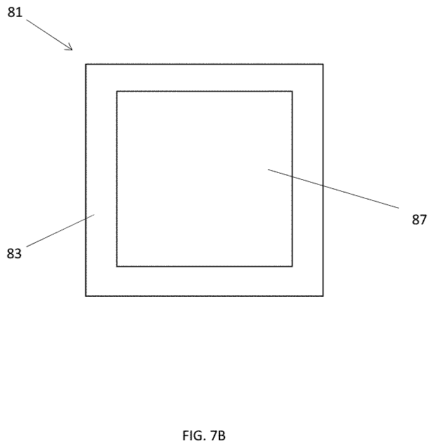

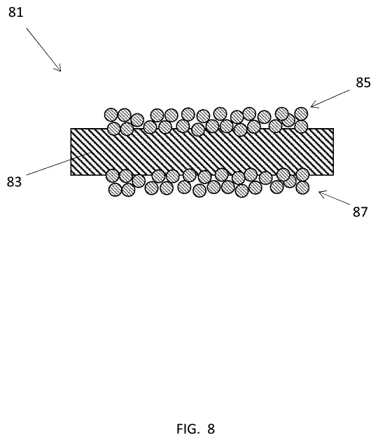

Referring now to FIGS. 7A, 7B, and 8, there are shown various views of one embodiment of a membrane electrode assembly fabricated according to method 101, the membrane electrode assembly being represented generally by reference numeral 81. (Certain details of membrane electrode assembly 81 that are discussed elsewhere in this application or that are not critical to an understanding of the invention may be omitted from one or more of FIGS. 7A, 7B and 8 and/or from the accompanying description herein or may be shown in one or more of FIGS. 7A, 7B and 8 and/or described herein in a simplified manner.)

Membrane electrode assembly 81 may be similar in many respects to membrane electrode assembly 31 and may include a solid polymer electrolyte membrane 83, which may be similar to solid polymer electrolyte membrane 12, and catalyst coatings 85 and 87, which may be similar to catalyst coatings 33 and 35. (For simplicity and clarity, only the catalyst component of catalyst coatings 33 and 35 is schematically shown in FIG. 8.) However, as can be seen best in FIG. 8, membrane electrode assembly 81 may differ from membrane electrode assembly 31 in that catalyst coatings 85 and 87 may be fused to and/or partially embedded within solid polymer electrolyte membrane 83. As a result, the contact between solid polymer electrolyte membrane 83 and catalyst coatings 85 and 87 is superior to that between solid polymer electrolyte membrane 12 and catalyst coatings 33 and 35. Therefore, the interfacial resistance between the membrane/electrode can be significantly reduced.

The fabrication process of the present invention may be applied to various types of electrochemical devices that utilize anion exchange membrane technology including, but not limited to, hydroxide exchange membrane water electrolyzers, hydroxide exchange membrane fuel cells, CO₂ electrolyzers, NH₃ electrolyzers, and reversible alkaline exchange membrane fuel cells.

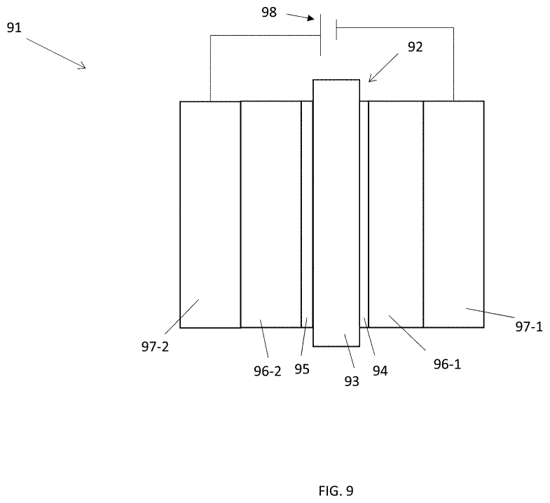

For example, referring now to FIG. 9, there is schematically shown one embodiment of an electrochemical device constructed according to the present invention, the electrochemical device being represented generally by reference numeral 91. (Certain details of electrochemical device 91 that are discussed elsewhere in this application or that are not critical to an understanding of the invention may be omitted from FIG. 9 and/or from the accompanying description herein or may be shown in FIG. 9 and/or described herein in a simplified manner.)

Electrochemical device 91, which may be in the form of an anion exchange membrane water electrolyzer, may comprise a membrane electrode assembly 92. Membrane electrode assembly 92, which may be made by method 101, may comprise an anion exchange membrane 93, a cathodic catalyst coating 94 on one of the opposing major surfaces of anion exchange membrane 93, and an anodic catalyst coating 95 on the other of the opposing major surfaces of anion exchange membrane 93.

Electrochemical device 91 may further comprise a cathodic gas diffusion layer 96-1 and an anodic gas diffusion layer 96-2. Cathodic gas diffusion layer 96-1 may be positioned along the exposed major surface of cathodic catalyst coating 94, and anodic gas diffusion layer 96-2 may be positioned along the exposed major surface of anodic catalyst coating 95. As can readily be appreciated, membrane electrode assembly 92 may be formed, in part, by depositing cathodic catalyst coating 94 on cathodic gas diffusion layer 96-1, depositing anodic catalyst coating 95 on anodic gas diffusion layer 96-2, and then fusing cathodic catalyst coating 94 and anodic catalyst coating 95 to opposing major surfaces of anion exchange membrane 93 in the manner described above. Alternatively, membrane electrode assembly 92 may be formed, in part, by depositing cathodic catalyst coating 94 and anodic catalyst coating 95 on opposing major surfaces of anion exchange membrane 93, then fusing cathodic catalyst coating 94 and anodic catalyst coating 95 to anion exchange membrane 93 in the manner described above, and then positioning cathodic and anodic gas diffusion layers 96-1 and 96-2 against the exposed major surfaces of cathodic catalyst coating 94 and anodic catalyst coating 95, respectively.

Electrochemical device 91 may further comprise a cathodic flow field 97-1 and an anodic flow field 97-2. Cathodic flow field 97-1 may be positioned along the exposed major surface of cathodic gas diffusion layer 96-1, and anodic flow field 97-2 may be positioned along the exposed major surface of anodic gas diffusion layer 96-2.

Electrochemical device 91 may further comprise a power source 98. Power source 98 may be operatively coupled to cathodic flow field 97-1 and anodic flow field 97-2.

Electrochemical device 91 may be used in the conventional fashion.

The following examples are given for illustrative purposes only and are not meant to be a limitation on the invention described herein or on the claims appended hereto.

### Example 1

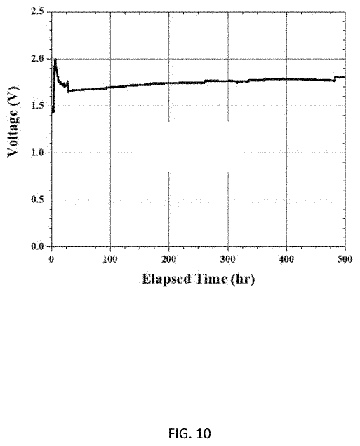

A membrane electrode assembly comprising a 20 μm thick poly(arylpiperidinium) hydroxide ion exchange membrane (Piperion TP-85) purchased from Versogen (Wilmington, Del.), a cathode of ˜2 mg/cm² (Pt) PtRu/C with ˜10 wt % TP-85 ionomer binder, and an anode of ˜3 mg/cm² IrO₂ with ˜20 wt % TP-85 ionomer binder was prepared. Prior to use, the membrane electrode assembly was activated by soaking in 3M KOH for 2 hours, followed by rinsing the membrane electrode assembly with deionized water. The membrane electrode assembly was assembled into Scribner electrolyzer hardware (Scribner Associates, Inc., Southern Pines, N.C.) utilizing Freudenberg H23C6 carbon paper (Freudenberg SE, Weinheim, Germany) for the cathode diffusion layer and 5 mil TEFLON™ polytetrafluoroethylene gasket on the cathode side, platinized titanium sinter for the anode diffusion layer and 10 mil TEFLON™ polytetrafluoroethylene gasket, POCO™ graphite serpentine flow field (Entegris, Inc., Billerica, Mass.) on the cathode and platinized titanium serpentine flow field on the anode. The cell was operated at 80° C. with a water flow rate of 0.07 mL/min·cm². The cell was broken in by a 0.1 A/cm² current density hold for thirty minutes, followed by a collection of a polarization curve. The cell was then operated for over 500 hours at 0.5 A/cm² flowing recirculated deionized water. The results of said operation are graphically depicted in FIG. 10. As can be seen therein, the maximum demonstrated operational lifetime is greater than 500 hours at 500 mA/cm².

### Example 2

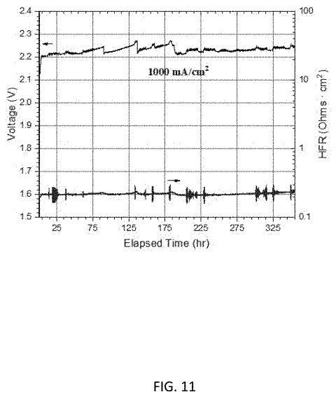

A membrane electrode assembly comprising a 80 μm thick poly(arylpiperidinium) hydroxide ion exchange membrane (Piperion TP-85) purchased from Versogen (Wilmington, Del.), a cathode of ˜2 mg/cm² (Pt) PtRu/C with ˜10 wt % TP-85 ionomer binder, and an anode of ˜3 mg/cm² IrO₂ with ˜20 wt % TP-85 ionomer binder was prepared. Prior to use, the membrane electrode assembly was activated by soaking in 3M KOH for 2 hours, followed by rinsing the membrane electrode assembly with deionized water. The membrane electrode assembly was assembled into Scribner electrolyzer hardware (Scribner Associates, Inc., Southern Pines, N.C.) utilizing Freudenberg H23C6 carbon paper (Freudenberg SE, Weinheim, Germany) for the cathode diffusion layer and 5 mil TEFLON™ polytetrafluoroethylene gasket on the cathode side, platinized titanium sinter for the anode diffusion layer and 10 mil TEFLON™ polytetrafluoroethylene gasket, POCO™ graphite serpentine flow field on the cathode (Entegris, Inc., Billerica, Mass.) and platinized titanium serpentine flow field on the anode. The cell was operated at 80° C. with a water flow rate of 0.07 mL/min·cm⁻². The cell was broken in by a 0.1 A/cm² current density hold for thirty minutes, followed by a collection of a polarization curve. The cell was then operated for over 325 hours at 1.0 A/cm² flowing deionized water. The results of said operation are graphically depicted in FIG. 11. As can be seen therein, the maximum demonstrated operational lifetime is greater than 300 hours at 1000 mA/cm².

As evidenced by Examples 1 and 2, the fabrication procedure of the present invention yields AEM membrane electrode assemblies that exhibit extended operational lifetimes. Such lifetimes are much greater than would be expected from comparable AEM membrane electrode assemblies not undergoing the two-part post-treatment process of the present invention.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method for fabricating a membrane electrode assembly, the method comprising the following steps:
(a) providing a solid polymer electrolyte membrane;
(b) positioning catalyst coatings against opposing surfaces of the solid polymer electrolyte membrane;
(c) then, swelling/plasticizing the solid polymer electrolyte membrane with a vapor of an aqueous ethanol solution; and
(d) then, pressing the catalyst coatings against the solid polymer electrolyte membrane to fuse and/or to partially embed the catalyst coatings into the solid polymer electrolyte membrane.

2. The method as claimed in claim 1 wherein the pressing step is performed at a temperature less than 100° C.

3. The method as claimed in claim 1 wherein each of the swelling/plasticizing step and the pressing step is performed at room temperature.

4. The method as claimed in claim 1 wherein the solid polymer electrolyte membrane comprises an anion exchange membrane.

5. The method as claimed in claim 4 wherein the anion exchange membrane is an alkaline exchange membrane.

6. The method as claimed in claim 5 wherein the alkaline exchange membrane is formed by functionalizing a material selected from the group consisting of polyethylene, polypropylene, polystyrene, polyarylene, poly(phenylene oxide), polybutadiene, polynorbornene, and poly(aryl piperidinium).

7. The method as claimed in claim 4 wherein the anion exchange membrane has a thickness of about 20-180 microns.

8. The method as claimed in claim 7 wherein the anion exchange membrane has a thickness of about 80 microns.

9. The method as claimed in claim 1 wherein said catalyst coatings positioning step comprises depositing an ionomer/catalyst ink on the solid polymer electrolyte membrane.

10. The method as claimed in claim 1 wherein said catalyst coatings positioning step comprises positioning at least one catalyst-coated substrate against the solid polymer electrolyte membrane.

11. The method as claimed in claim 1 wherein one of the catalyst coatings comprises a first catalyst, the first catalyst being suitable for at least one of a hydrogen evolution reaction or a hydrogen oxidation reaction, and wherein another one of the catalyst coatings comprises a second catalyst, the second catalyst being suitable for at least one of an oxygen evolution reaction or an oxygen reduction reaction.

12. The method as claimed in claim 1 wherein the aqueous ethanol solution comprises ethanol and water in relative amounts that range from 1:10 to 4:1, by volume, respectively.

13. The method as claimed in claim 12 wherein the aqueous ethanol solution comprises ethanol and water in a 4:1 ratio, by volume, respectively.

14. The method as claimed in claim 12 wherein said swelling/plasticizing step is performed in a sealed container for a duration of about 10-100 minutes.

15. The method as claimed in claim 14 wherein, during said swelling/plasticizing step, the solid polymer electrolyte membrane is retained under tension in a frame.

16. The method as claimed in claim 1 wherein said pressing step comprises applying a force of about 1000-10,000 lbs. for about 2-30 minutes.

17. The method as claimed in claim 16 wherein said pressing step comprises pressing the catalyst coatings against the solid polymer electrolyte membrane using a pair of mold plates.

18. The method as claimed in claim 16 wherein said pressing step comprises pressing the catalyst coatings against the solid polymer electrolyte membrane using a pair of mold plates that are separated by a pair of rubber layers that, in turn, are separated by a pair of polytetrafluoroethylene layers.

19. The membrane electrode assembly made by the method of claim 1.

20. The membrane electrode assembly made by the method of claim 3.

21. The membrane electrode assembly made by the method of claim 6.

22. The membrane electrode assembly made by the method of claim 7.

23. The membrane electrode assembly made by the method of claim 9.

24. The membrane electrode assembly made by the method of claim 12.

25. The membrane electrode assembly made by the method of claim 16.

26. An electrochemical device comprising the membrane electrode assembly of claim 19.

27. A method for applying a catalyst coating to a solid polymer electrolyte membrane, the method comprising the following steps:
(a) providing a solid polymer electrolyte membrane;
(b) positioning a catalyst coating against a surface of the solid polymer electrolyte membrane;
(c) then, swelling or plasticizing the solid polymer electrolyte membrane with a vapor of an aqueous ethanol solution; and
(d) then, pressing the catalyst coating against the solid polymer electrolyte membrane to fuse and/or to partially embed the catalyst coating into the solid polymer electrolyte membrane.

28. The method as claimed in claim 27 wherein the pressing step is performed at a temperature less than 100° C.

29. The method as claimed in claim 27 wherein each of the swelling/plasticizing step and the pressing step is performed at room temperature.

30. The method as claimed in claim 27 wherein the solid polymer electrolyte membrane is an anion exchange membrane.

31. The method as claimed in claim 30 wherein the aqueous ethanol solution comprises ethanol and water in relative amounts that range from 1:10 to 4:1, by volume, respectively.

32. The method as claimed in claim 31 wherein said swelling/plasticizing step is performed in a sealed container for a duration of about 10-100 minutes.

33. The method as claimed in claim 32 wherein, during said swelling/plasticizing step, the solid polymer electrolyte membrane is retained under tension in a frame.

34. The method as claimed in claim 27 wherein said pressing step comprises applying a force of about 1000-10,000 lbs. for about 2-30 minutes.

35. The method as claimed in claim 34 wherein said pressing step comprises pressing the catalyst coatings against the solid polymer electrolyte membrane using a pair of mold plates.

36. The method as claimed in claim 27 wherein said catalyst coating positioning step comprises depositing an ionomer/catalyst ink on the solid polymer electrolyte membrane.

37. The method as claimed in claim 27 wherein said catalyst coating positioning step comprises positioning a catalyst-coated substrate against the solid polymer electrolyte membrane.

38. The coated solid polymer electrolyte membrane as claimed in claim 27.

39. The coated solid polymer electrolyte membrane as claimed in claim 30.

40. The coated solid polymer electrolyte membrane as claimed in claim 31.

41. The coated solid polymer electrolyte membrane as claimed in claim 34.

42. An electrochemical device comprising the coated solid polymer electrolyte membrane as claimed in claim 38.
